(19) United States
(12) Patent Application Publication
(10) Pub. No.: US 2018/0352155 A1
(43) Pub. Date: Dec. 6, 2018

(54) MONITORING SYSTEM

(71) Applicant: GOOEE LIMITED, SHEUNG WAN (HK)

(72) Inventors: CHUN-KUANG CHEN, TAOYUAN CITY (TW); TUNG-YU CHEN, HSINCHU COUNTY (TW); JI-DE HUANG, HSINCHU CITY (TW)

(21) Appl. No.: 15/784,705

(22) Filed: Oct. 16, 2017

Related U.S. Application Data
(60) Provisional application No. 62/513,709, filed on Jun. 1, 2017.

(51) Int. Cl. H04N 5/232; G06T 7/70; H04N 5/225; H04N 5/235

(52) U.S. Cl. CPC H04N 5/23235; G06T 7/70; G02B 3/0006; H04N 5/2354; G06T 2207/30232; H04N 5/2256

(57) ABSTRACT

A monitoring system includes an image capturing device arranged to generate an image data of a scene; and a coordinate generating device arranged to calculate a coordinate of an object in the scene according to the image data.

### CROSS-REFERENCE TO RELATED APPLICATION

This application claims the benefit of U.S. Application No. 62/513,709, filed Jun. 1, 2017.

### BACKGROUND

In a monitoring system, a camera is used to monitor an indoor or outdoor space. However, the monitoring system may have privacy issue if the monitoring system is hacked. Moreover, when an abnormal or emergency situation occurs in a scene, the conventional monitoring system does not have the ability to calculate the position of a target in the scene. For example, when a target (e.g., a person) is detected in a spacious indoor locale (such as, a large marketplace), a conventional monitoring system system cannot determine the position of the object in said locale.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. in fact, the dimensions of the various features may be arbitrarily increased or reduced for clarity of discussion.

FIG. 1 is a diagram illustrating a monitoring system in accordance with some embodiments.

FIG. 2 is a diagram illustrating an image capturing device in accordance with some embodiments.

FIG. 3 is a diagram illustrating another image capturing device in accordance with some embodiments.

FIG. 4 is a diagram illustrating another image capturing device in accordance with some embodiments.

FIG. 5 is a diagram illustrating another image capturing device in accordance with sonic embodiments.

FIG. 6 is a diagram illustrating a non-parallel ray pattern in accordance with some embodiments.

FIG. 7 is a diagram illustrating the forming of a non-parallel ray pattern in accordance with sonic embodiments,

FIG. 8 is a diagram illustrating the scanning of a non-parallel ray pattern on a horizontal plane in accordance with sonic embodiments.

FIG. 9 is a diagram illustrating a coordinate generating device in accordance with some embodiments.

FIG. 10 is a diagram illustrates the relation between a scanning time and an angle of a first light beam in accordance with some embodiments.

FIG. 11 is a diagram illustrating a top view of a coordinate generating device in accordance with some embodiments.

FIG. 12 is a diagram illustrating a side view of a coordinate generating device in accordance with some embodiments.

FIG. 13 is a diagram illustrates the relation between a time difference and an angle in accordance with some embodiments.

FIG. 14 is a diagram illustrating a top view of a coordinate generating device in accordance with sonic embodiments.

FIG. 15 is a diagram illustrating a side view of a coordinate generating device during the scanning process in accordance with some embodiments.

FIG. 16 is a diagram illustrating a side view of the coordinate generating device in accordance with some embodiments.

FIG. 17 is a timing diagram illustrating a detecting signal in accordance with some embodiments.

FIG. 18 is a timing diagram illustrating another detecting signal in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the. first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Embodiments of the present disclosure are discussed in detail below. It should be appreciated, however, that the present disclosure provides many applicable inventive concepts that can be embodied in a wide variety of specific contexts. The specific embodiments discussed are merely illustrative and do not limit the scope of the disclosure.

Further, spatially relative terms, such as “beneath,” “below,” “lower,” “above,” “upper”, “lower”, “left”, “right” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. It will he understood that when an element is referred to as being “connected to” or “coupled to” another element, it may be directly connected to or coupled to the other element, or intervening elements may be present.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can he expressed herein as from one endpoint to another endpoint or between two endpoints. All ranges disclosed herein are inclusive of the endpoints, unless specified otherwise.

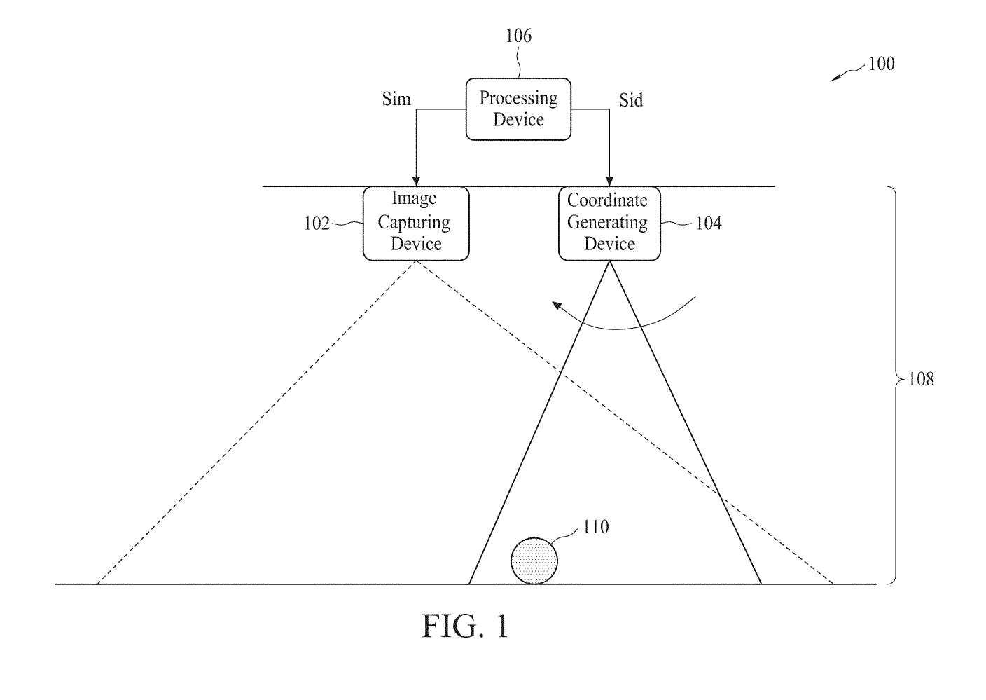

FIG. 1 is a diagram illustrating a monitoring system 100 in accordance with some embodiments. The monitoring system 100 may be arranged to monitor an indoor or outdoor space. For indoor space, the monitoring system 100 may be installed on a ceiling or a wall of a building. For outdoor space, the monitoring system 100 may be installed on a facade of a building or a lamppost on the street. According to some embodiments, the monitoring system 100 comprises an image capturing device 102, a coordinate generating device 104, and a processing device 106. The image capturing device 102 is arranged to generate an image data Sim of a scene 108. The image data Sim may be a picture or a video of the scene 108. The coordinate generating device 104 is arranged to scans the scene 108 for calculating a coordinate of an object 110 in the scene 108 according to the image data Sim. The processing device 106 is coupled to the image capturing device 102 and the coordinate generating device 104 for generating an indicating signal Sid according to the image data Sim, wherein the coordinate generating device 104 generates the coordinate of the object in response to the indicating signal Sid. According to some embodiments, the image capturing device 102, the coordinate generating device 104, and the processing device 106 may be installed on the same or different places of the space.

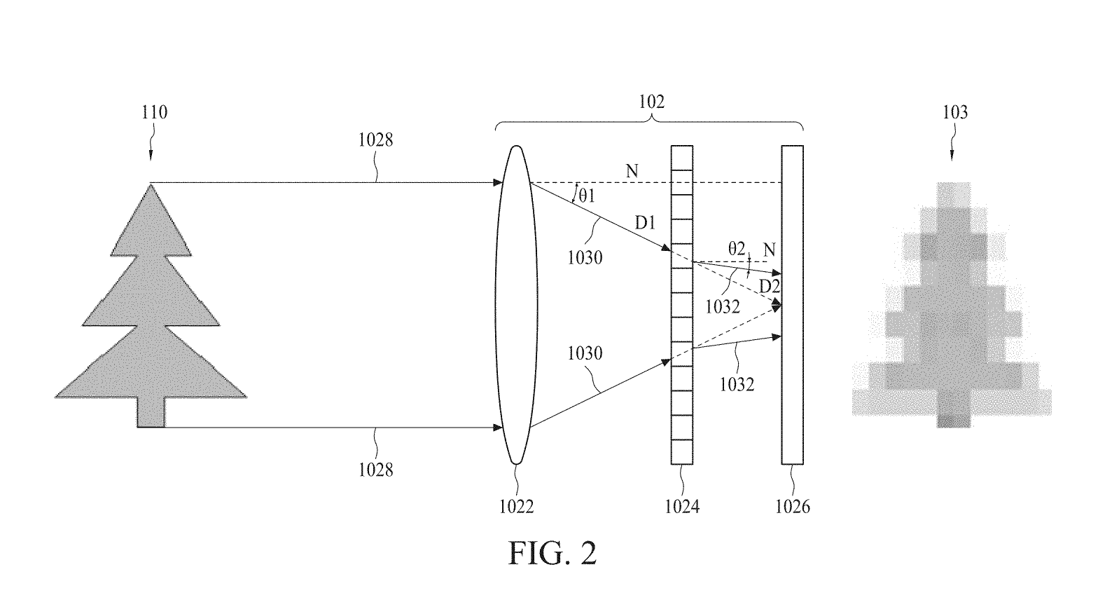

FIG. 2 is a diagram illustrating the image capturing device 102 in accordance with some embodiments. Due to the privacy issue, the image data Sim generated by the image capturing device 102 is a pixelated/blurred image or a pixelated/blurred video of the scene 108. The resolution of the image data Sim is lower than a predetermined resolution R1, e.g. 10 mega-pixels. The predetermined resolution R1 is remarkably lower than a regular resolution that human eye can distinguish. For example, the predetermined resolution R1 may be 64*64 or lower pixels. When the resolution of the image data Sim is lower than the predetermined resolution R1, the detailed features of the scene 108 are not shown on the image data Sim. Accordingly, the privacy issue of the image capturing device 102 being hacked is solved.

For brevity, the image capturing device 102 is arranged to generate a pixelated image 103 of the object 110. The image capturing device 102 comprises a first deflecting device 1022, a second deflecting device 1024, and an image sensing device 1026. According to some embodiments, the first deflecting device 1022 comprises a single lens, and the second deflecting device 1024 comprises a plurality of relatively small lens formed as a grid pattern on a transparent plate. The first deflecting device 1022 is arranged to deflect an incoming light signal 1028 corresponding to the object 110 to generate a first deflected light signal 1030 with a first direction D1. The second deflecting device 1024 is arranged to deflect the first deflected light signal 1030 to generate a second deflected light signal 1032 with a second direction D2 different from the first direction D1. The image sensing device 1026 has a device resolution R2 for generating the image data. Sim having the predetermined resolution R1 by sensing the second deflected light signal 1032, wherein the predetermined resolution R1 is lower than the device resolution R2. According to some embodiments, a first included angle θ1 is formed between the first direction 1030 and a normal direction N of the image sensing device 1026 or the second deflecting device 1024, a second included angle θ2 is formed between the second direction 1032 and the normal direction N of the image sensing device 1026 or the second deflecting device 1024, and the first included angle θ1 is greater than the second included angle θ2.

In other words, the second deflecting device 1024 is arranged to make the light path of the second deflected light signal 1032 deviate from the original direction (i.e. D1) of the light path of the first deflected light signal 1030 such that the focal point is not formed on the image sensing device 1026. Therefore, when the second deflecting device 1024 is omitted, the first deflecting device 1022 is arranged to deflect the incoming light signal 1028 to focus on the image sensing device 1026 the dashed line in FIG. 2). When the second deflecting device 1024 is disposed between the first deflecting device 1022 and the image sensing device 1026, the first deflected light signal 1030 is defocused on the image sensing device 1026 (i.e. the second deflected light signal 1032). When the first deflected light signal 1030 is defocused on the image sensing device 1026, the image data Sim (e.g. 303) formed by sensing the second deflected light signal 1032 may have a resolution (i.e. the predetermined resolution R1′ lower than the device resolution R2. More specifically, when the second deflecting device 1024 is omitted, the focal point of the first deflected light signal 1030 may form on the image sensing device 1026. When the second deflecting device 1024 is disposed between the first deflecting device 1022 and the image sensing device 1026, the second deflecting device 1024 may deviate the first deflected light signal 1030 to make the second deflected light signal 1032 defocus on the image sensing device 1026. Accordingly, a pixelated image or a blurred image (e.g. 103) of the scene 108 may be generated by the image sensing device 1026.

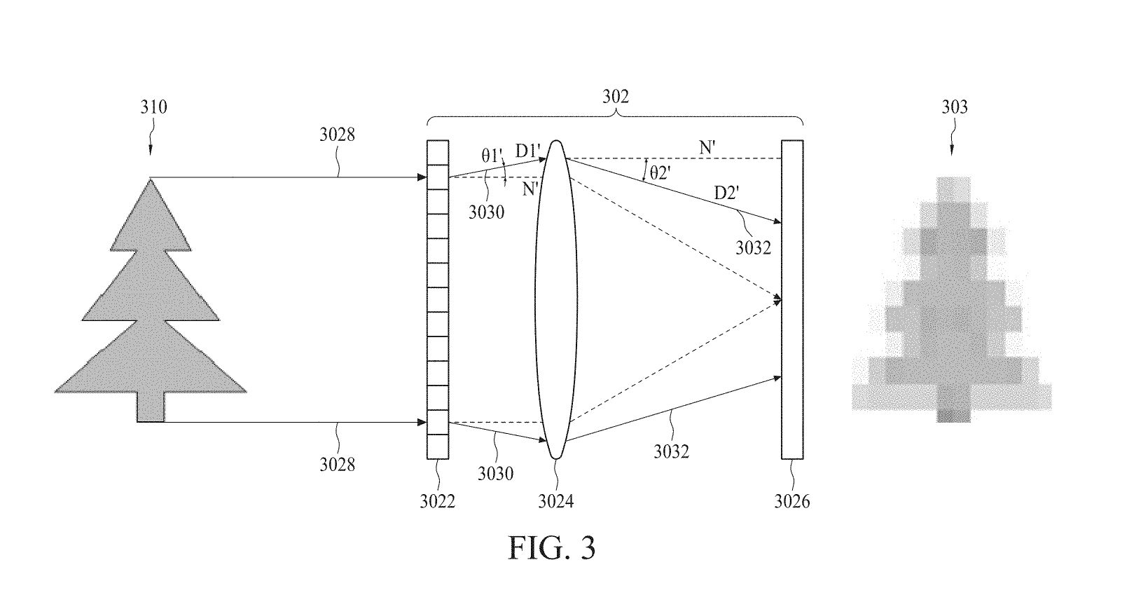

FIG. 3 is a diagram illustrating an image capturing device 302 in accordance with some embodiments. The image capturing device 302 is arranged to generate a pixelated image 303 of the object 310. The image capturing device 302 comprises a first deflecting device 3022, a second deflecting device 3024, and an image sensing device 3026. According to some embodiments, the first deflecting device 3022 comprises a plurality of relatively small lens formed as a grid pattern on a transparent plate The second deflecting device 3024 comprises a single lens. The first deflecting device 3022 is arranged to deflect an incoming light signal 3028 corresponding to the object 310 to generate a first deflected light signal 3030 with a first direction D1′. The second deflecting device 3024 is arranged to deflect the first deflected light signal 3030 to generate a second deflected light signal 3032 with a second direction D2′ different from the first direction D1′. The image sensing device 3026 has a device resolution R2′ for generating the image data Sim′ having the predetermined resolution R1′ by sensing the second deflected light signal 3032, wherein the predetermined resolution R1′ is lower than the device resolution R2′. According to some embodiments, a first included angle θ1′ is formed between the first direction D1′ and a normal direction N′ of the image sensing device 3026 or the first deflecting device 3022, a second included angle θ2′ is formed between the second direction D2′ and the normal direction N′ of the image sensing device 3026. According to some embodiments, the first included angle θ1′ is smaller than the second included angle θ2′. However, in some embodiments, the first included angle θ1′ may greater than the second included angle θ2′.

In other words, the first deflecting device 3022 is arranged to make the light path of the first deflected light signal 3030 deviate from the original direction (i.e. the horizontal direction) of the light path of the incoming light signal 3028 such that the focal point is not formed on the image sensing device 3026. Therefore, when the first deflecting device 3022 is omitted, the second deflecting device 3024 is arranged to deflect the incoming light signal 3028 to focus on the image sensing device 3026 (i.e. the dashed line in FIG. 3). When the first deflecting device 3022 is disposed between the object 310 and the second deflecting device 3024, the second deflected light signal 3032 is defocused on the image sensing device 3026. When the second deflected light signal 3032 is defocused on the image sensing device 3026, the image data Sim′ (e.g. 303) formed by sensing the second deflected light signal 3032 may have a resolution (i.e. the predetermined resolution R1′) lower than the device resolution R2′. More specifically, when the first deflecting device 3022 is omitted, the focal point of the second deflected light signal 3032 may form on the image sensing device 3026. When the first deflecting device 3022 is disposed between the object 310 and the second deflecting device 3024, the first deflecting device 3022 may deviate the incoming light signal 3028 to make the second deflected light signal 3032 to defocus on the image sensing device 3026. Accordingly, a pixelated image or a blurred image (e.g. 303) of the scene 108 is generated by the image sensing device 3026.

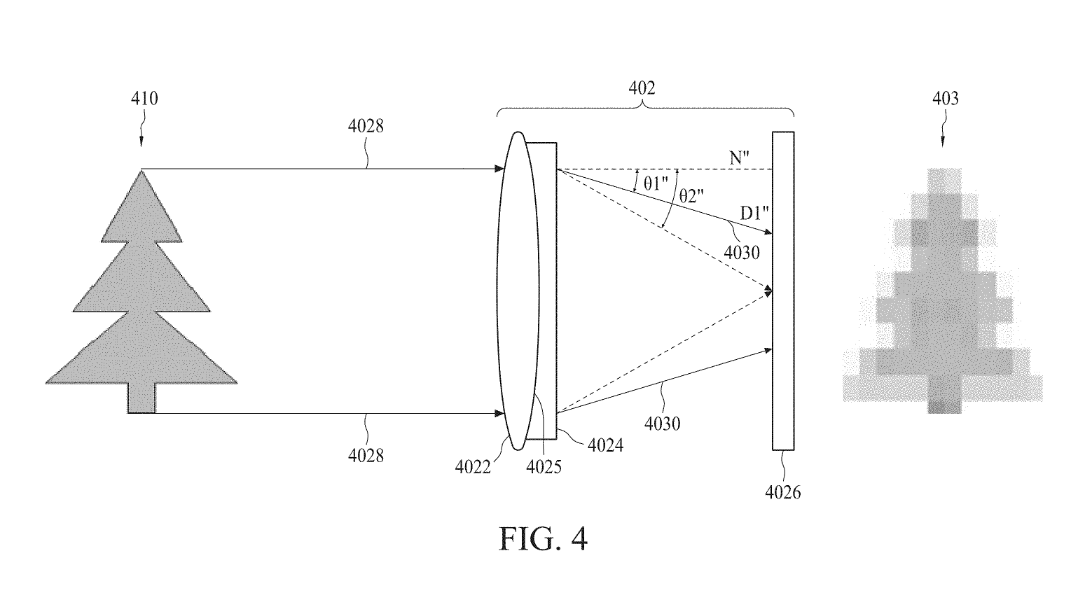

FIG. 4 is a diagram illustrating an image capturing device 402 in accordance with some embodiments. The image capturing device 402 is arranged to generate a pixelated image 403 of the object 410. The image capturing device 402 comprises a first deflecting device 4022, a second deflecting device 4024, and an image sensing device 4026. According to some embodiments, the first deflecting device 4022 is a transparent lens, and the second deflecting device 4024 is a matte lens formed on a surface 4025 of the transparent lens (i.e. the first deflecting device 4022). Moreover, the second deflecting device 4024 is disposed between the first deflecting device 4022 and the image sensing device 4026. The first deflecting device 4022 in combination with the second deflecting device 4024 is arranged to deflect an incoming light signal 4028 corresponding to the object 410 to generate a deflected light signal 4030 with a direction D1″. The image sensing device 4026 has a device resolution R2″ for generating the image data Sim″ having the predetermined resolution R1″ by sensing the deflected light signal 4030, wherein the predetermined resolution R1″ is lower than the device resolution R2″.

In other words, when the second deflecting device 4024 is omitted, the first deflecting device 4022 is arranged to deflect the incoming light signal 4028 to focus on the image sensing device 4026. When the second deflecting device 4024 is disposed on the surface 4025 of the first deflecting device 4022, the deflected light signal 4030 is defocused on the image sensing device 4026. Accordingly, the image data Sim″ formed by sensing the deflected light signal 4030 may have a resolution (i.e. the predetermined resolution R1″) lower than the device resolution R2″. More specifically, when the second deflecting device 4024 is omitted, the focal point of the deflected light signal 4030 may form on the image sensing device 4026. When the second deflecting device 4024 is disposed on the surface 4025 of the first deflecting device 4022, the second deflecting device 4024 may defocus the deflected light signal 4030 on the image sensing device 4026. Accordingly, a pixelated image or a blurred image (e.g. 403) of the scene 108 is generated by the image sensing device 4026. According to some embodiments, a first included angle θ1″ is formed between the direction D1″ and a normal direction N″ of the image sensing device 4026. The first included angle θ1″ is smaller than an included angle θ2″ in which the second deflecting device 4024 is omitted.

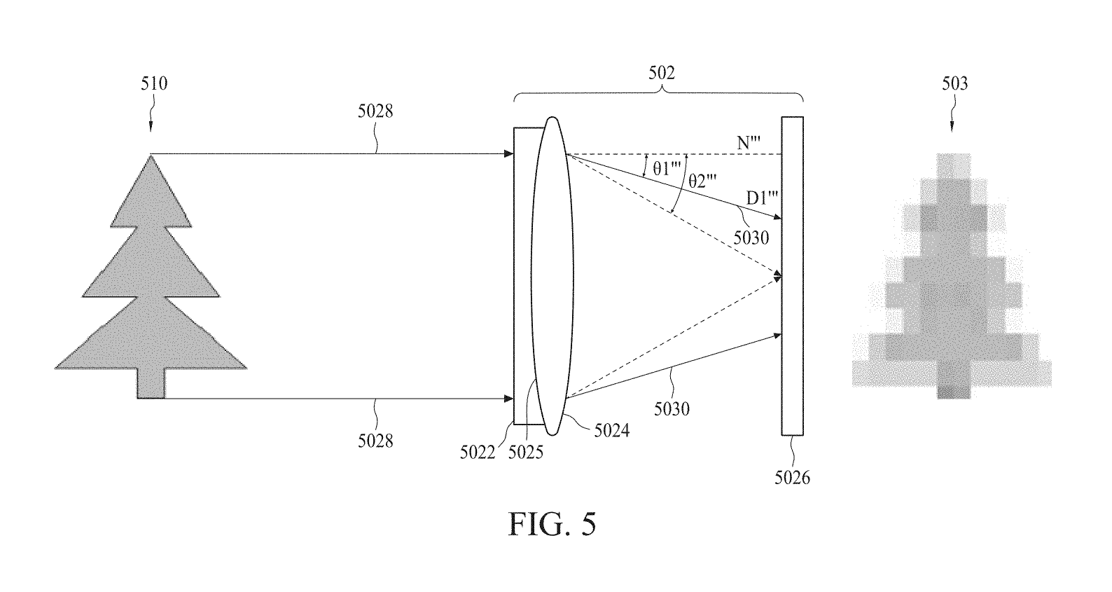

FIG. 5 is a diagram illustrating an image capturing device 502 in accordance with some embodiments. The image capturing device 502 is arranged to generate a pixelated image 503 of the object 510. The image capturing device 502 comprises a first deflecting device 5022, a second deflecting device 5024, and an image sensing device 5026. According to some embodiments, the first deflecting device 5022 is a matte lens, and the second deflecting device 5024 is a transparent lens. The matte lens (i.e. the first deflecting device 5022) is formed on a surface 5025 of the transparent lens (i.e. the second deflecting device 5024). Moreover, the first deflecting device 5022 is disposed between the second deflecting device 5024 and the object 510. The first deflecting device 5022 in combination with the second deflecting device 5024 is arranged to deflect an incoming light signal 5028 corresponding to the object 510 to generate a deflected light signal 5030 with a direction D1′″. The image sensing device 5026 has a device resolution R2′″ for generating the image data Sim′″ having the predetermined resolution R1′″ by sensing the deflected light signal 5030, wherein the predetermined resolution R1′″ is lower than the device resolution R2′″.

In other words, when the first deflecting device 5022 is omitted, the second deflecting device 5024 is arranged to deflect the incoming light signal 5028 to focus on the image sensing device 5026. When the first deflecting device 5022 is disposed on the surface 5025 of the second deflecting device 5024, the s deflected light signal 5030 is defocused on the image sensing device 5026. Accordingly, the image data Sim′″ formed by sensing the deflected light signal 5030 may have a resolution the predetermined resolution R1′″) lower than the device resolution R2′″. More specifically, when the first deflecting device 5022 is omitted, the focal point of the deflected light signal 5030 may form on the image sensing device 5026. When the first deflecting device 5022 is disposed on the surface 5025 of the second deflecting device 5024, the first deflecting device 5022 may defocus the deflected light signal 5030 on the image sensing device 5026. Accordingly, a pixelated image or a blurred image (e.g. 503) of the scene 108 is generated by the image sensing device 5026. According to some embodiments, a first included angle θ1′″ is formed between the direction D1′″ and a normal direction N′″ of the image sensing device 5026. The first included angle θ1′″ is smaller than an included angle θ2′″ in which the second deflecting device 5024 is omitted.

According to some embodiments, the deflecting devices 1024, 3022, 4024 and/or 5022 may be replaced with an optical filter. The optical filter is arranged to filter out the color of the incoming light signal such that the image data becomes a monochrome image.

According to some embodiments, an optical filter may be disposed on the second deflecting device 4024 and/or the first deflecting device 5022. The optical filter is arranged to filter out the color of the incoming light signal such that the image data becomes a monochrome image.

When a pixelated image or a blurred image of the scene is generated by the image sensing device, a processing device (e.g. 106) is arranged to analyze the image data. As the image data has a relatively lower resolution, the processing device 106 may not generate a great amount of data during the analysis, and the efficiency of analyzing the image data is increased. Furthermore, the processing device 106 outputs the indicating signal Sid to the coordinate generating device 104 when the processing device 106 detects an impulse or pulse signal, for example, from the image data. The impulse signal may be caused by the abnormal reaction or behavior of an object/target in the scene 108. For example, when the object in the scene 108 is a person, and when the person slips on floor of a monitored area, the processing device 106 outputs the indicating signal Sid to the coordinate generating device 104 after analysis. Then, the coordinate generating device 104 calculates the coordinate of the object according to the indicating signal Sid.

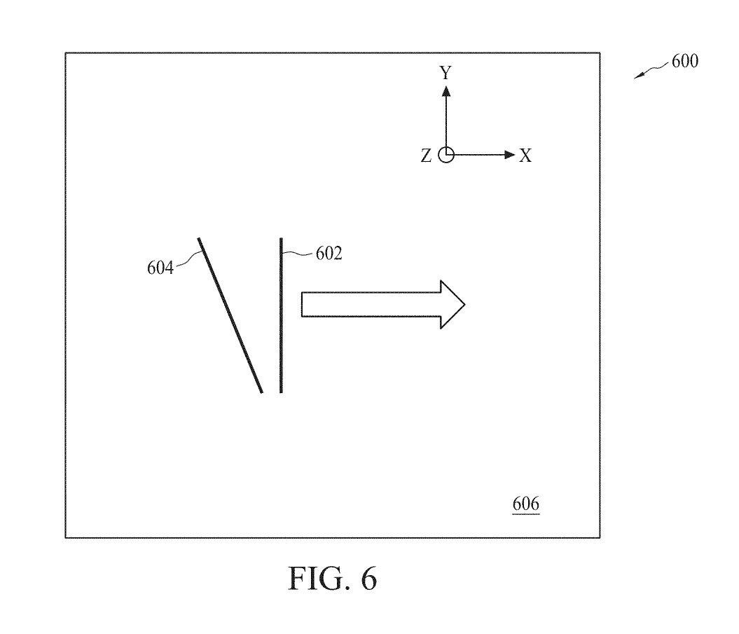

In addition, the coordinate generating device 104 is arranged to generate a non-parallel ray pattern to scan the object in the scene 108 for calculating the coordinate of the object. FIG. 6 is a diagram illustrating a non-parallel ray pattern 600 in accordance with some embodiments. The non-parallel ray pattern 600 comprises a first ray 602 and a second ray 604. The non-parallel ray pattern 600 is a ray pattern projecting on the horizontal plane 606 that supports the object. It is noted that, for brevity, the first ray 602 is a straight ray parallel to the Y-axis, and the second ray 604 is an inclined straight ray having a predetermined slope. The non-parallel ray pattern 600 may be a V-shape ray pattern. According to some embodiments, the non-parallel ray pattern 600 scans the horizontal plane 606 along a direction parallel to X-axis.

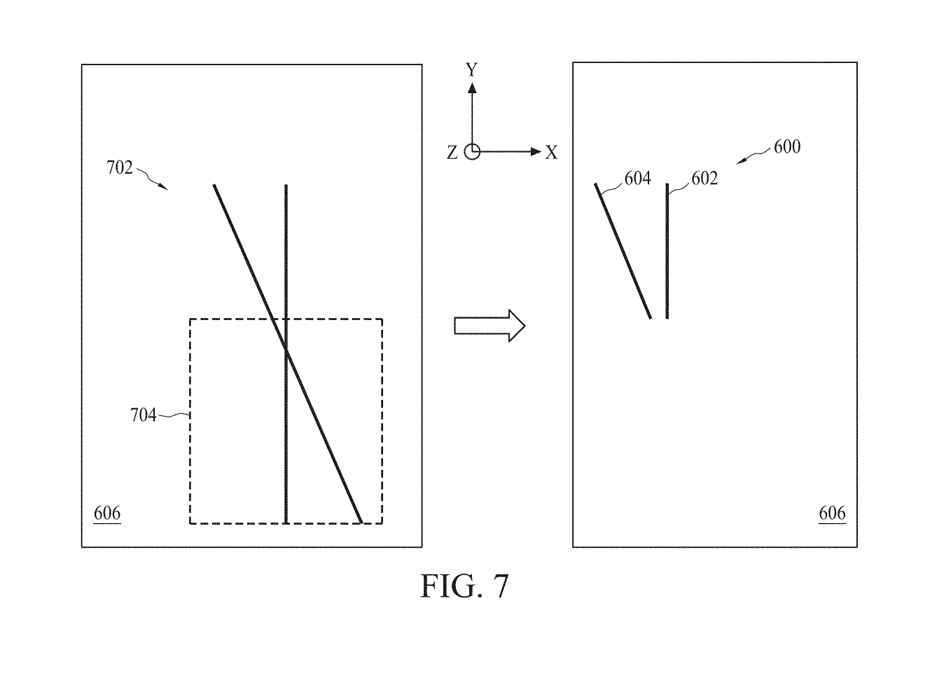

According to some embodiments, the first ray 602 and the second ray 604 may be laser beams. The first ray 602 and the second ray 604 may be formed by covering up a portion of two laser beams that is configured to be an X-shape. FIG. 7 is a diagram illustrating the forming of the non-parallel ray pattern 600 in accordance with some embodiments. In FIG. 7, an X-shape laser beam 702 is generated by a light generating device. The light generating device may be a laser emitter. According to some embodiments, a half or more than a half of the X-shape laser beam 702 is blocked by a mask 704 before the X-shape laser beam 702 projecting on the horizontal plane 606. When the X-shape laser beam 702 is blocked, the non-parallel ray pattern 600 is formed on the horizontal plane 606. The mask may be installed on an output terminal of the light generating device, in which the output terminal is used to output the X-shape laser beam 702.

Moreover, the coordinate generating device 104 further comprises a MEMS micromirror. The blocked X-shape laser beam projects on the MEMS micromirror, and the MEMS micromirror is arranged to rotate by a predetermined or fixed angular velocity to make the first ray 602 and the second ray 604 synchronously scan the horizontal plane 606 in a straight direction by a predetermined velocity.

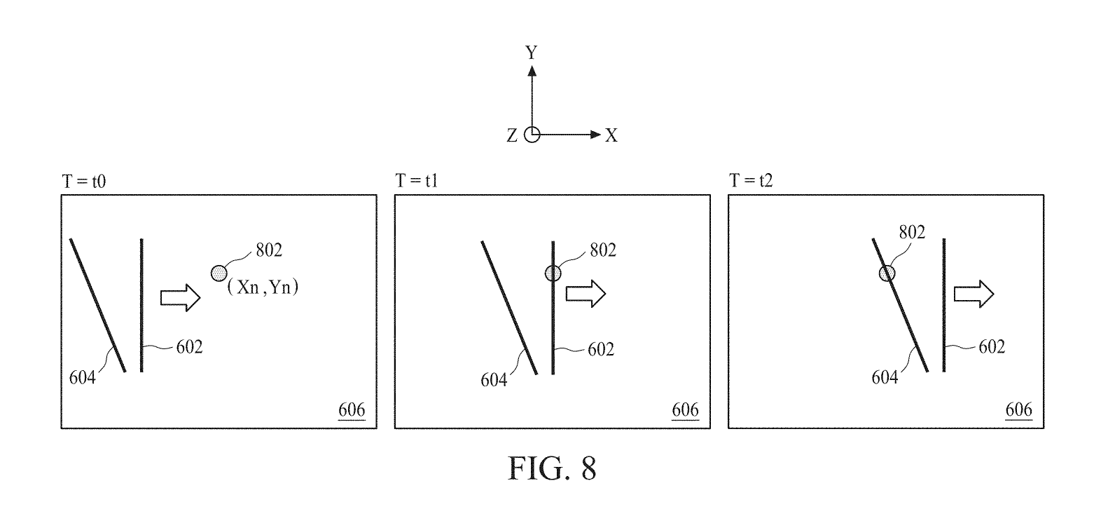

FIG. 8 is a diagram illustrating the scanning of the non-parallel ray pattern 600 on the horizontal plane 606 in accordance with some embodiments. At time t0, the first ray 602 and the second ray 604 starts to scan the horizontal plane 606 from a side (e.g. the left side) of the horizontal plane 606. At time t1, the first ray 602 scans to the object 802, and the coordinate generating device 104 records the time t1. At time t2, the second ray 604 scans to the object 802, and the coordinate generating device 104 records the time t2. It is assumed that the coordinate of the object 802 on the horizontal plane 606 is (Xn, Yn), in which Xn is the distance on X-axis of the horizontal plane 606, and Yn is the distance on Y-axis of the horizontal plane 606. According to some embodiments, by using the coordinate generating device 104, the time t1 in combination with the time t0 may be used to calculate the value of Xn, and the time t2 in combination with the times t0 and t1 may he used to calculate the value of in. According to some embodiments, when the time difference t2−t1 is greater, the value of Yn is greater, and vice versa.

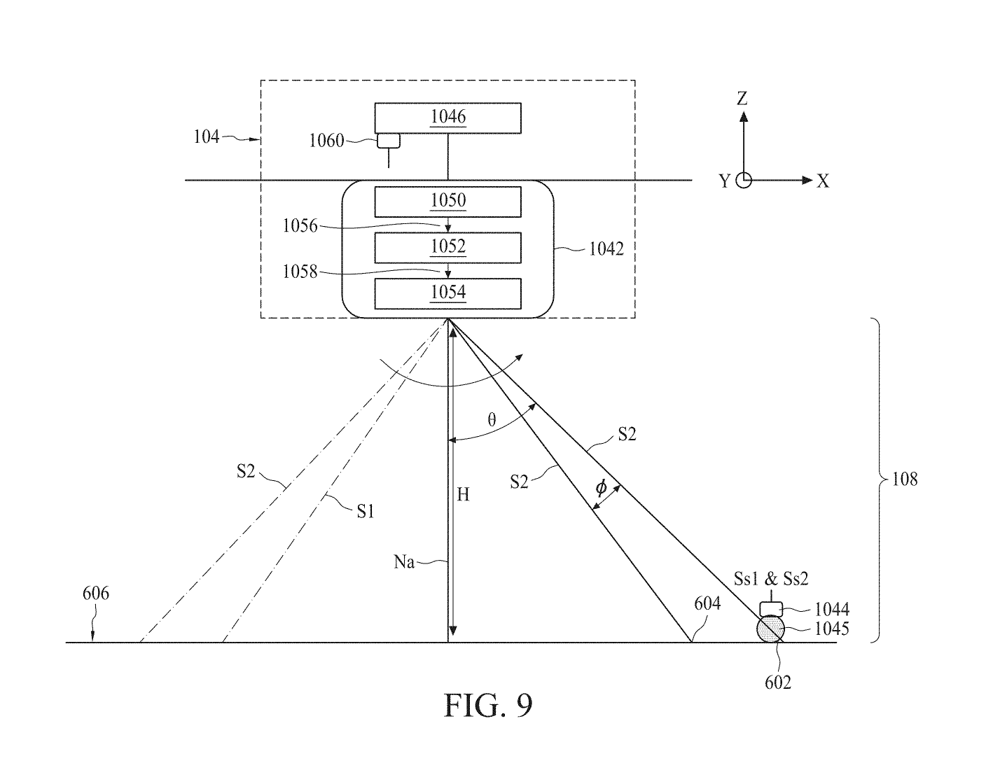

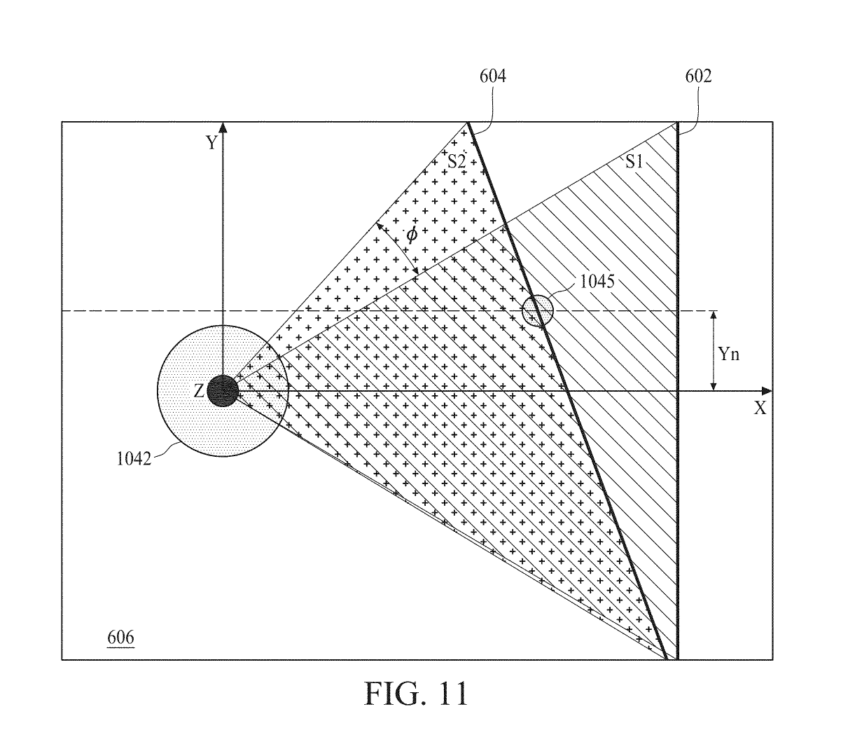

FIG. 9 is a diagram illustrating the coordinate generating device 104 in accordance with some embodiments. The coordinate generating device 104 comprises a light generating device 1042, a sensing device 1044, and a controlling device 1046. The light generating device 1042 is arranged to generate a first light beam S1 and a second light beam S2. The first light beam S1 and the second light beam S2 have a predetermined angle φ (also shown in FIG. 11) therebetween such that the non-parallel ray pattern (i.e. 602 and 604) formed on the horizontal plane 606 supporting the object 1045. The sensing device 1044 is coupled to an object 1045 for generating a first sensing signal Ss1 and a second sensing signal Ss2 when the first light beam S1 and the second light beam S2 scans on the object 1045 respectively. The controlling device 1046 is coupled to the light generating device 1042 for calculating a coordinate of the object 1045 according to the first sensing signal Ss1 and the second sensing signal Ss2. According to some embodiment, the controlling device 1046 comprises a wireless receiver 1060 arranged to wirelessly receive the first sensing signal Ss1 and the second sensing signal Ss2 from the sensing device 1044.

The light generating device 1042 comprises a laser head 1050, a mask 1052, and a MEMS micromirror 1054. The laser head 1050 is arranged to output an X-shape laser beam 1056. The mask 1052 is installed on the output terminal of the laser head 1050, in which the laser head 1050 outputs the X-shape laser beam 1056 via the output terminal. The mask 1052 is arranged to block a half or more than a half of the X-shape laser beam 1056 to form a non-parallel ray 1058. The non-parallel ray 1058 projects on the MEMS micromirror 1054, and the MEMS micromirror 1054 is arranged to rotate by a predetermined or fixed angular velocity to make the first light beam S1 and the second light beam S2 synchronously scan the horizontal plane 606 by the fixed angular velocity. Accordingly, as shown in FIG. 6, the first ray 602 and the second ray 604 formed by the first light beam S1 and the second light beam S2 respectively may synchronously scan the horizontal plane 606 in a straight direction, i.e. from the left side to the right side.

According to some embodiments, the first ray 602 and the second ray 604 are arranged to scan the horizontal plane 606 from the left side to the right side on the X-axis. In this embodiment, the first ray 602 is a straight ray parallel to the Y-axis, and the second ray 604 is an inclined straight ray having a predetermined slope as shown in FIG. 6. At Z-axis, the light generating device 1042 has a predetermined height H measured from the horizontal plane 606. When the first ray 602 scans on the object 1045, the sensing device 1044 generates the first sensing signal Ss1 at the time t1. Therefore, the occurrence time of the first sensing signal Ss1 is t1. The first sensing signal Ss1 is transmitted to the controlling device 1046. The time t1 and the corresponding angle θ between the first light beam S1 and the vertical direction Na may be obtained from the light generating device 1042 and the controlling device 1046. As the first ray 602 is a straight ray parallel to the Y-axis, the value of Xn of the coordinate (Xn, Yn) can be obtained by the following equation (1):

Xn=H*tan (θ) (1)

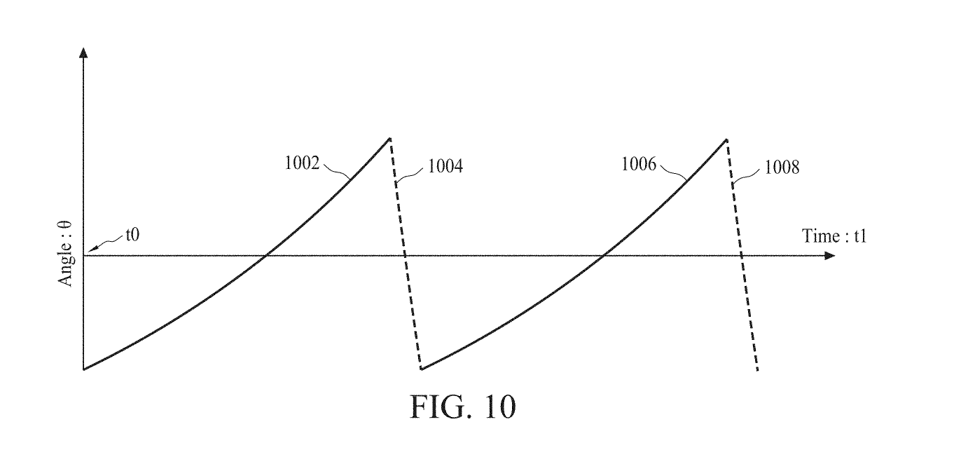

FIG. 10 is a diagram illustrates the relation between the time t1 and the angle θ in accordance with some embodiments. The curve 1002 (or 1006) shows a scanning process from the left side to the right side variation of the horizontal plane 606. During the scanning process, the laser head 1050 is turned on, and the MEMS micromirror 1054 is arranged to rotate a predetermined angle from an initial angle at time t0. The dashed curve 1004 (or 1008) shows a stop-scanning process. During the stop-scanning process, the laser head 1050 is turned off, and the MEMS micromirror 1054 is arranged to rotate back to the initial angle. The scanning process and the stop-scanning process are alternately repeated to scan the horizontal plane 606. According to some embodiments, the relation between the time t1 and the angle θ may be linear or non-linear.

In addition, the values of the relation between the time t1 and the angle θ may he pre-calculated and stored in a lookup table. The light generating device 1042 may directly map and read the required angle θ from the lookup table according to the time t1.

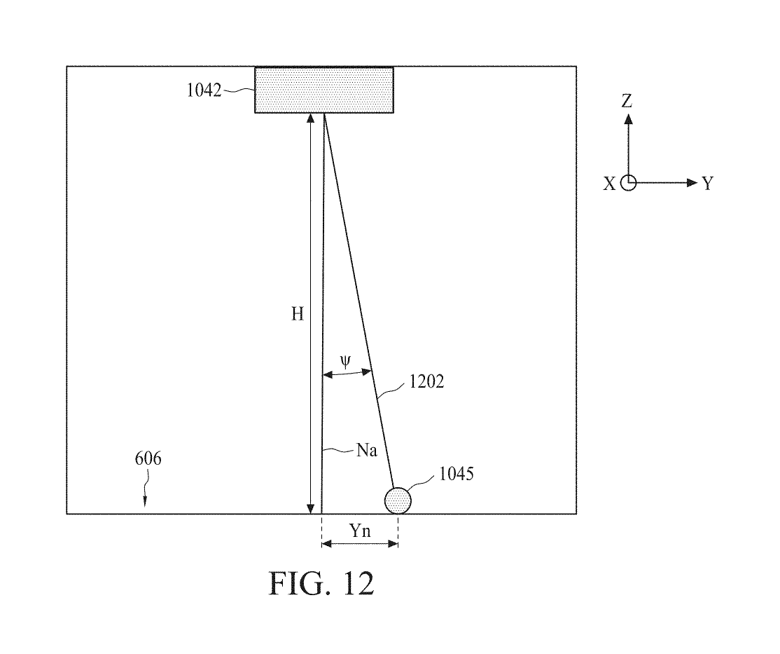

Moreover, after the first ray 602. scans on the object 1045, the second ray 604 may scan on the object 1045 at time t2. FIG. 11 is a diagram illustrating a top view of the coordinate generating device 104 when the second ray 604 scans on the object 1045 at time t2 in accordance with some embodiments. FIG. 12 is a diagram illustrating a side view of the coordinate generating device 104 from X-axis when the second ray 604 scans on the object 1045 at time t2 in accordance with some embodiments. When the second ray 604 is an inclined straight ray having a predetermined slope, the included angle between the first ray 602 and the second ray 604 is also a predetermined/known angle. The sensing device 1044 generates the second sensing signal Ss2 at the time t2. Therefore, the occurrence time of the second sensing signal Ss2 is t2. The second sensing signal Ss2 is transmitted to the controlling device 1046. The time difference t2−t1 is proportional to the angle ϕ between the vertical direction Na and a straight line 1202 connecting the object 1045 and the light generating device 1042. According to some embodiments, the angle ϕ is proportional to the value of Yn of the coordinate (Xn, Yn). The value of Yn of the coordinate (Xn, Yn) can he obtained by the following equation (2):

Yn=H*tan (ϕ) (2)

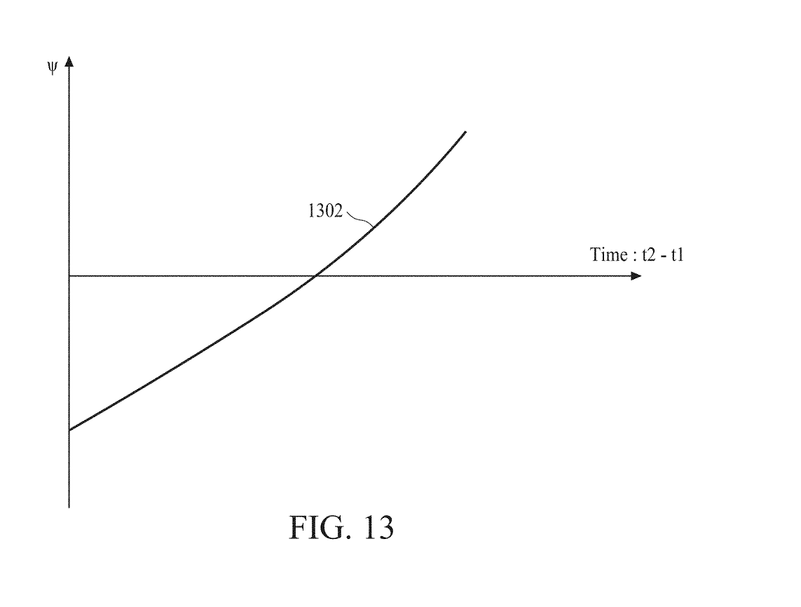

FIG. 13 is a diagram illustrates the relation between the time difference t2−t1 and the angle ϕ in accordance with some embodiments. The curve 1302 the variation of the angle ϕ with respect to the time difference t2−t1 when the object 1045 is moved from the bottom side to the top side of the horizontal plane 606 (i.e. from the left side to the right side on Y-axis of FIG. 12). According to some embodiments, the relation between the time difference t2−t1 and the angle ϕ may he linear or non-linear.

In addition, the values of the relation between the time difference t2−t1 and the angle ϕ may be pre-calculated and stored in a lookup table. The light generating device 1042. may directly map and read the required angle from the lookup table according to the time difference t2−t1.

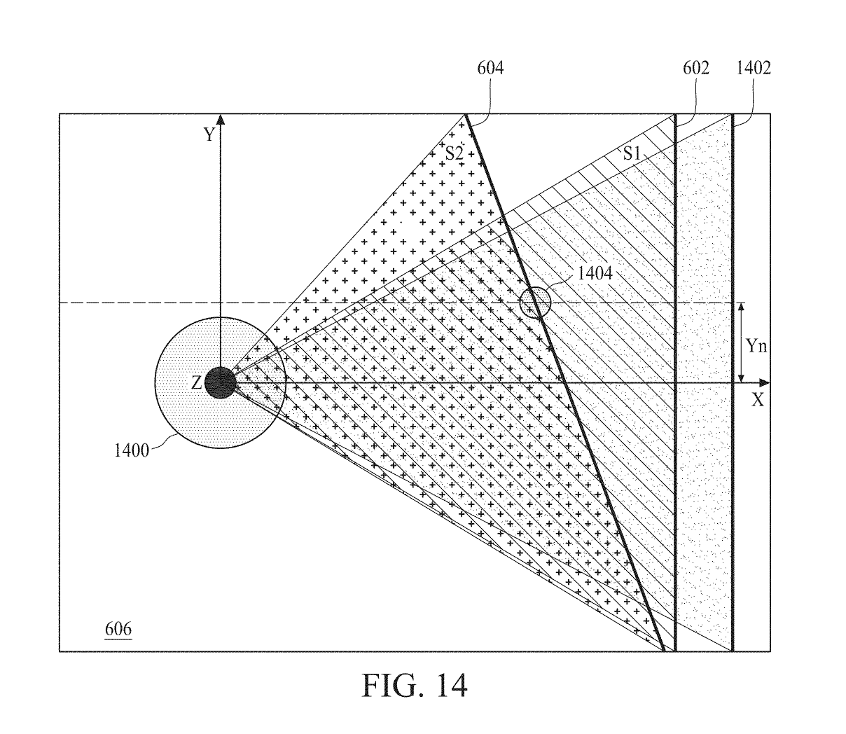

It is noted that the coordinate generating device 104 in FIG. 9 shows a device for calculating the 2D (2-dimensional) position of an object. This not a limitation of the present invention. The coordinate generating device 104 may be modified to calculate the 3D (3-dimensional) position of an object. FIG. 14 is a diagram illustrating a top view of a coordinate generating device 1400 in accordance with some embodiments. For brevity, some numerals in FIG. 14 are similar to the numerals in FIG. 11. In comparison to the coordinate generating device 104 of FIG. 11, the coordinate generating device 1400 further generates a third light beam S3. The third light beam S3 forms a third ray 1402 on the horizontal plane 606. According to some embodiments, the third ray 1402 is parallel to the second ray 602. The coordinate generating device 1400 is arranged to calculate the 3D coordinate (Xn, Yn, Zn) of an object. 1404.

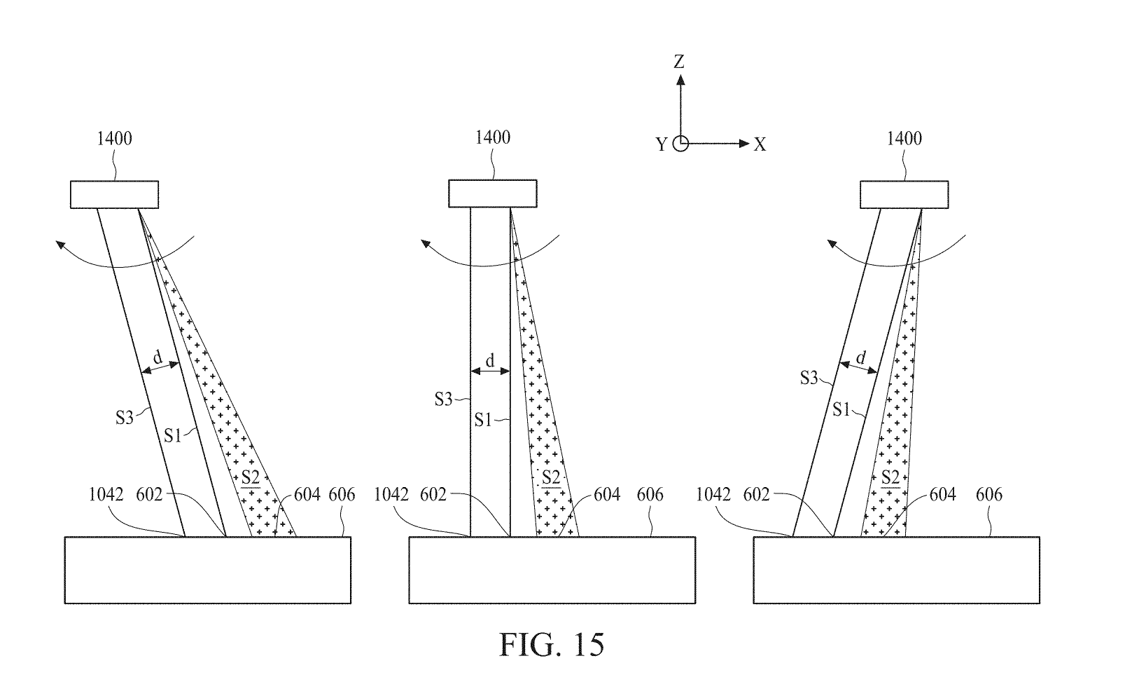

FIG. 15 is a diagram illustrating a side view of the coordinate generating device 1400 during the scanning process in accordance with some embodiments. The first light beam S1 and the third light beam S3 are shown as two parallel lines, and the second light beam S2 is shown as a triangle. This is because the first light beam S1 is parallel to the third light beam S3, and the second light beam S2 is not parallel to the first light beam S1 and the third light beam S3. Moreover, the distance d between the first light beam S1 and the third light beam S3 is substantially a fixed distance during the scanning of the first light beam S1, the second light beam S2, and the third light beam S3.

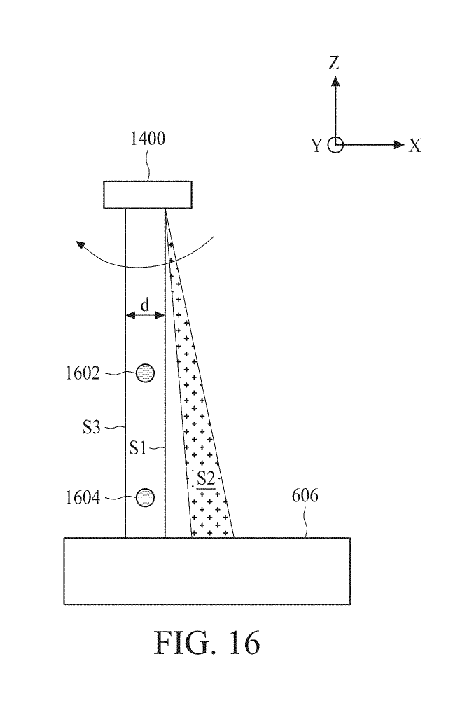

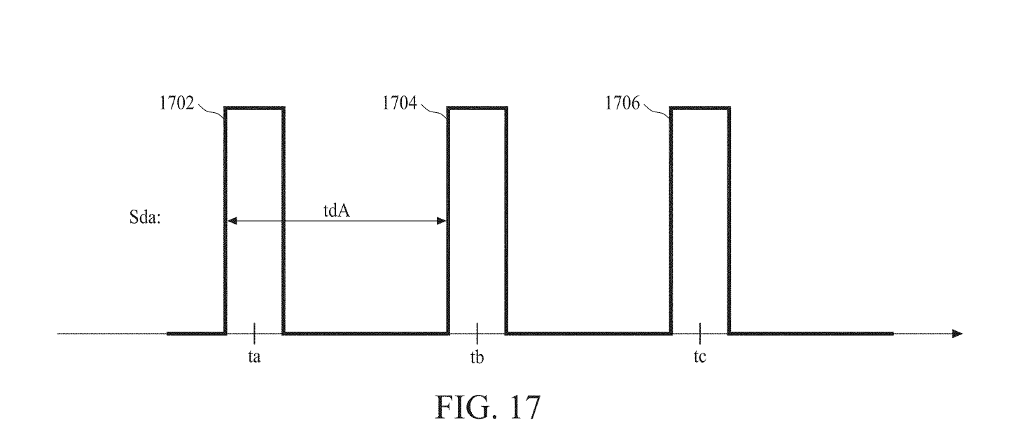

FIG. 16 is a diagram illustrating a side view of the coordinate generating device 1400 in accordance with sonic embodiments. When an object 1602 is located on the position A above the horizontal plane 606, the coordinate generating device 1400 may receive a detecting signal Sda from the sensing device 1044 when the light walls or edges of the third light beam S3, the first light beam S1, and the second light beam S2 scan on the object 1602 at different time points respectively. According to some embodiments, the sensing device 1044 may generate three sensing signals when the light walls or edges of the third light beam S3, the first light beam S1, and the second light beam S2 scan on the object 1602 respectively. The detecting signal Sda may be the combined signal of the three sensing signals. FIG. 17 is a timing diagram illustrating the detecting signal Sda in accordance with sonic embodiments. The detecting signal Sda has three pulses 1702, 1704, and 1706 at times ta, tb, and tc respectively. The pulses 1702, 1704, and 1706 are generated when the third light beam S3, the first light beam S1, and the second light beam S2 scan on the object 1602. respectively. Therefore, the times ta, tb, and tc are also the occurrence times of the three sensing signals generated by the sensing device 1044. A time interval tdA between the pulse 1702 and the pulse 1704 is obtained.

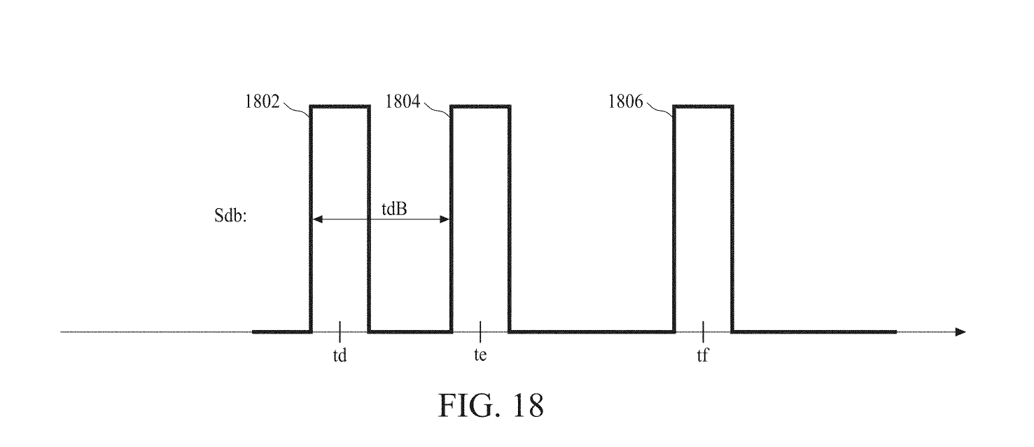

On the other hand, when an object 1604 is located on the position B above the horizontal plane 606 and lower than the position B, the coordinate generating device 1400 may receive a detecting signal Sdb from the sensing device 1044 when the light walls or edges of the third light beam S3, the first light beam S1, and the second light beam S2. scan on the object 1604 at different time points respectively. Similarly, the sensing device 1044 may generate three sensing signals when the light walls or edges of the third light beam S3, the first light beam S1, and the second light beam S2 scan on the object 1604 respectively. The detecting signal Sdb may be the combined signal of the three sensing signals. FIG. 18 is a timing diagram illustrating the detecting signal Sdb in accordance with some embodiments. The detecting signal Sda has three pulses 1802, 1804, and 1706 at times td, te, and tf respectively. The pulses 1802, 1804, and 1806 are generated when the third light beam S3, the first light beam S1, and the second light beam S2 scan on the object 1604 respectively. Therefore, the times td, te, and tf are also the occurrence times of the three sensing signals generated by the sensing device 1044. A time interval tdB between the pulse 1802 and the pulse 1804 is obtained.

According to FIG. 17 and FIG. 18, although the first light beam S1, the second light beam S2, and the third light beam S3 have the same angular velocity, the object 1602 and the object 1604 are scanned by the first light beam S1, the second light beam S2, and the third light beam S3 on different times. This is because the coordinate generating device 1400 is closer to the object 1602 than the object 1604. Therefore, the time interval tdB is shorter than the time interval tdA. In other words, the value of Zn of the coordinate (Xn, Yn, Zn) of the object 1602 (or 1604) may be obtained by analyzing the time interval between the pulse caused by the third light beam S3 and the pulse caused by the first light beam S1. In addition, the values of the relation between the value of Zn and the time interval between the pulse caused by the third light beam S3 and the pulse caused by the first light beam S1 may he pre-calculated and stored in a lookup table. The light generating device 1400 may directly map and read the required Zn from the lookup table according to the time interval. It is noted that the values of Xn and Yn of the coordinate (Xn, Yn, Zn) of the object 1602 (or 1604) may he calculated by using the methods disclosed in the above embodiments, thus the detailed description is omitted for brevity.

Briefly, the present invention provides a monitoring system without violating the privacy of user. The monitoring system is capable of calculating the 2D or 3D coordinate of a target in a scene.

According to some embodiments, a monitoring system is provided. The monitoring system comprises an image capturing device and a coordinate generating device. The image capturing device is arranged to generate an image data of a scene. The coordinate generating device is arranged to calculate a coordinate of an object in the scene according to the image data.

According to some embodiments, an image capturing device is provided. The image capturing device comprises a first deflecting device, a second deflecting device, and an image sensing device. The first deflecting device is arranged to deflect an incoming light signal corresponding to an object to generate a first deflected light signal beam with a first direction. The second deflecting device is arranged to deflect the first deflected light signal to generate a second deflected light signal with a second direction different from the first direction. The image sensing device has a first resolution for generating an image data having a second resolution by sensing the second deflected light signal, wherein the second resolution is lower than the first resolution.

According to some embodiments, a coordinate generating device is provided. The coordinate generating device comprises a light generating device, a sensing device, and a controlling device. The light generating device is arranged to generate a first light beam and a second light beam. The sensing device is coupled to an object for generating a first sensing signal and a second sensing signal when the first light beam and the second light beam scans on the object respectively. The controlling device is coupled to the light generating device for calculating a coordinate of the object according to the first sensing signal and the second sensing signal.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A monitoring system, comprising:
an image capturing device, arranged to generate an image data of a scene; and
a coordinate generating device, arranged to calculate a coordinate of an object in the scene according to the image data.

2. The monitoring system of claim 1, wherein the image capturing device comprises:
a first deflecting device, arranged to deflect an incoming light signal corresponding to the object to generate a first deflected light signal with a first direction;
a second deflecting device, arranged to deflect the first deflected light signal to generate a second deflected light signal with a second direction different from the first direction; and
an image sensing device, having a first resolution, for generating the image data having a second resolution by sensing the second deflected light signal, wherein the second resolution is lower than the first resolution.

3. The monitoring system of claim 2, wherein the first deflecting device comprises a single lens, and the second deflecting device comprises a plurality of lens formed as a grid pattern.

4. The monitoring system of claim 3, wherein a first included angle is formed between the first direction and a normal direction of the image sensing device, a second included angle is formed between the second direction and the normal direction of the image sensing device, and the first included angle is greater than the second included angle.

5. The monitoring system of claim 2, wherein the first deflecting device comprises a plurality of lens formed as a grid pattern, and the second deflecting device comprises a single lens.

6. The monitoring system of claim 5, a first included angle is formed between the first direction and a normal direction of the image sensing device, a second included angle is formed between the second direction and the normal direction of the image sensing device, and the first included angle is smaller than the second included angle.

7. The monitoring system of claim 2, wherein the first deflecting device is a transparent lens, and the second deflecting device is a matte lens formed on a surface of the transparent lens.

8. The monitoring system of claim 1, further comprising:
a processing device, coupled to the image capturing device, for generating an indicating signal by analyzing the image data;
wherein the coordinate generating device generates the coordinate of the object according to the indicating signal.

9. The monitoring system of claim 8, wherein the processing device generates the indicating signal to the coordinate generating device when the processing device detects an impulse signal from the image data.

10. The monitoring system of claim 8, wherein the coordinate generating device comprises:
a light generating device, arranged to generate a first light beam and a second light beam;
a sensing device, coupled to the object, for generating a first sensing signal and a second sensing signal when the first light beam and the second light beam scans on the object respectively; and
a controlling device, coupled to the light generating device for calculating the coordinate according to the first sensing signal and the second sensing signal.

11. The monitoring system of claim 10, wherein the first light beam and the second light beam have a predetermined angle therebetween such that a non-parallel ray pattern formed on a horizontal plane supporting the object.

12. The monitoring system of claim 11, wherein the non-parallel ray pattern is substantially a V-shape ray pattern.

13. The monitoring system of claim 11, wherein the light generating device controls the first light beam and the second light beam to synchronously scan the horizontal plane in a straight direction.

14. The monitoring system of claim 11, wherein the controlling device is arranged to calculate the coordinate according to a first occurrence time and a second occurrence time of the first sensing signal and the second sensing signal respectively.

15. The monitoring system of claim 11, wherein the light generating device controls the first light beam and the second light beam to synchronously scan the horizontal plane by a fixed angular velocity.

16. The monitoring system of claim 11, wherein the controlling device further comprises:
a wireless receiver, arranged to wirelessly receive the first sensing signal and the second sensing signal from the sensing device.

17. The monitoring system of claim 10, wherein the light generating device further generates a third light beam parallel to one of the first light beam and the second light beam, the sensing device further generates a third sensing signal when the third light beam scans on the object, and the controlling device further uses the third sensing signal to calculate the coordinate.

18. The monitoring system of claim 17, wherein the light generating device controls the first light beam, the second light beam, and the third light beam to synchronously scan the horizontal plane in a straight direction.

19. The monitoring system of claim 17, wherein the controlling device is arranged to calculate the coordinate according to a first occurrence time, a second occurrence time, and a third occurrence time of the first sensing signal, the second sensing signal, and the third sensing signal respectively.

20. The monitoring system of claim 17, wherein the light generating device controls the first light beam, the second light beam, and the third light bean to synchronously scan the horizontal plane by a fixed angular velocity.

21. An image capturing device, comprising:
a first deflecting device, arranged to deflect an incoming light signal corresponding to an object to generate a first deflected light signal beam with a first direction;
a second deflecting device, arranged to deflect the first deflected light signal to generate a second deflected light signal with a second direction different from the first direction; and
an image sensing device, having a first resolution, for generating an image data having a second resolution by sensing the second deflected light signal, wherein the second resolution is lower than the first resolution.

22. The image capturing device of claim 21, wherein the first deflecting device comprises a single lens, and the second deflecting device comprises a plurality of lens formed as a grid pattern.

23. The image capturing device of claim 22, wherein a first included angle is formed between the first direction and a normal direction of the image sensing device, a second included angle is formed between the second direction and the normal direction of the image sensing device, and the first included angle is greater than the second included angle.

24. The image capturing device of claim 21, wherein the first deflecting device comprises a plurality of lens formed as a grid pattern, and the second deflecting device comprises a single lens.

25. The image capturing device of claim 24, wherein a first included angle is formed between the first direction and a normal direction of the image sensing device, a second included angle is formed between the second direction and the normal direction of the image sensing device, and the first included angle is smaller than the second included angle.

26. The image capturing device of claim 21, wherein the first deflecting device is a transparent lens, and the second deflecting device is a matte lens formed on a surface of the transparent lens.

27. A coordinate generating device, comprising:
a light generating device, arranged to generate a first light beam and a second light beam;
a sensing device, coupled to an object, for generating a first sensing signal and a second sensing signal when the first light beam and the second light beam scans on the object respectively; and
a controlling device, coupled to the light generating device for calculating a coordinate of the object according to the first sensing signal and the second sensing signal.

28. The coordinate generating device of claim 27, wherein the first light beam and the second light beam have a predetermined angle therebetween such that a non-parallel ray pattern formed on a horizontal plane supporting the object.

29. The coordinate generating device of claim 28, wherein the non-parallel ray pattern is substantially a V-shape ray pattern.

30. The coordinate generating device of claim 28, wherein the light generating device controls the first light beam and the second light beam to synchronously scan the horizontal plane in a straight direction.

31. The coordinate generating device of claim 28, wherein the controlling device is arranged to calculate the coordinate according to a first occurrence time and a second occurrence time of the first sensing signal and the second sensing signal respectively.

32. The coordinate generating device of claim 28, wherein the light generating device controls the first light beam and the second light beam to synchronously scan the horizontal plane by a fixed angular velocity.

33. The coordinate generating device of claim 11, wherein the controlling device further comprises:
a wireless receiver, arranged to wirelessly receive the first sensing signal and the second sensing signal from the sensing device.

34. The coordinate generating device of claim 27, wherein the light generating device further generates a third light beam parallel to one of the first light beam and the second light beam, the sensing device further generates a third sensing signal when the third light beam scans on the object, and the controlling device further uses the third sensing signal to calculate the coordinate.

35. The coordinate generating device of claim 34, wherein the light generating device controls the first light beam, the second light beam, and the third light beam to synchronously scan the horizontal plane in a straight direction.

36. The coordinate generating device of claim 34, wherein the controlling device is arranged to calculate the coordinate according to a first occurrence time, a second occurrence time, and a third occurrence time of the first sensing signal, the second sensing signal, and the third sensing signal respectively.

37. The coordinate generating device of claim 34, wherein the light generating device controls the first light beam, the second light beam, and the third light beam to synchronously scan the horizontal plane by a fixed angular velocity.
